(19) United States
(12) Patent Application Publication
(10) Pub. No.: US 2026/0066795 A1
(43) Pub. Date: Mar. 5, 2026

(54) TRANSIENT VOLTAGE LIMITING REGULATOR (TLVR) WITH TRANSFORMER COMPENSATION

(71) Applicant: NVIDIA Corporation, Santa Clara, CA (US)

(72) Inventors: Wei-Ting Chen, Taichung City (TW); Rui Chen, Shanghai (CN); Yu Kuo Chiang, New Taipei City (TW)

(21) Appl. No.: 18/819,546

(22) Filed: Aug. 29, 2024

(51) Int. Cl. H02M 3/158; H01F 27/28; H02M 1/00; H02M 1/088; H02M 1/14

(52) U.S. Cl. CPC H02M 3/1584; H01F 27/28; H02M 1/0064; H02M 1/088; H02M 1/14

(57) ABSTRACT

A first transformer includes a first primary winding and a first secondary winding. The first primary winding is coupled to a first phase branch to produce a first waveform. The first secondary winding is serially coupled to a compensation branch. A second transformer includes a second primary winding and a second secondary winding. The second primary winding is coupled to a second phase branch to produce a second waveform. The second secondary winding is serially coupled to the first secondary winding. An output node is coupled to the first phase branch and the second phase branch to provide an output waveform. The output waveform includes the first waveform and the second waveform, and has a transient response based on a first harmonic factor of the first phase branch and a second harmonic factor of the second phase branch.

### TECHNICAL FIELD

At least one embodiment pertains to electrical system components for power delivery, particularly active electrical components. For example, at least one embodiment pertains to a trans-inductance voltage limiting regulator (TLVR) with transformer compensation.

### BACKGROUND

In many systems, particularly complex electrical systems, consistent delivery of power is necessary for optimal performance. A power delivery system or circuit can manage the flow of electrical power to a system, electrical component, or circuit. Some power delivery systems can condition a power input waveform such that the power input waveform has one or more of appropriate voltage, current, impedance, or phase value(s).

### BRIEF DESCRIPTION OF DRAWINGS

Various embodiments in accordance with the present disclosure will be described with reference to the drawings, in which:

FIG. 1 illustrates a block diagram of an example system for implementing a TLVR with transformer compensation, according to at least one aspect of the disclosure.

FIG. 2 illustrates a block diagram of an example system for implementing a TLVR with transformer compensation, according to at least one aspect of the disclosure.

FIG. 3A illustrates a circuit diagram of an example circuit for implementing a TLVR with transformer compensation, according to at least one aspect of the disclosure.

FIG. 3B illustrates a circuit diagram of an example circuit for implementing a TLVR with transformer compensation, according to at least one aspect of the disclosure.

FIG. 4 illustrates a block diagram of an example environment for implementing a TLVR with transformer compensation in a system, according to at least one aspect of the disclosure.

FIG. 5 is a block diagram illustrating an exemplary computer system, such as computer system, which can be a system with interconnected devices and components, a system-on-a-chip (SOC), or some combination thereof, according to aspects of the disclosure.

FIG. 6 is a block diagram illustrating an electronic device for utilizing a processor, according to aspects of the disclosure.

### DETAILED DESCRIPTION

Embodiments described herein are directed to a trans-inductor voltage regulator (TLVR) with transformer compensation. Power delivery circuits can be used to condition power waveform inputs to systems, electrical components, circuits, and the like. Often the design of power circuitry involves a balance of trade-offs. The functionality of the power circuitry can be balanced with the complexity of the power circuitry, manufacturing tolerances or constraints, cost to produce the power circuitry, available area on a circuit board, efficiency of the power circuitry, or reliability of the power circuitry. For example, example, a larger fixed-value components that is manufactured to a high-degree of precision can provide a high level of performance in power circuitry. However, the high level of performance can often come with challenges such as a higher cost to produce the power circuitry, a larger footprint of the power circuitry, an increased power draw of the power circuitry, and increase trace routing complexity to integrate the power circuitry with other electrical components or circuits. It can be appreciated then, that power circuitry that can improve performance in one area, while at least maintaining similar performance in other areas can represent an important improvement on existing power circuitry and systems.

Many sensitive electrical systems can pre-condition power waveforms received from a power source in an attempt to provide a “cleaner” power waveform (e.g., reduced noise, or more consistent) to the sensitive electrical systems. Often, providing a cleaner power waveform to the sensitive electrical systems allows designers to further optimize the electrical system for increased performance and/or efficiency. In a particular example, a TLVR can be added to power delivery circuitry to help mitigate transient voltage spikes or other electrical surges in an electrical system. A “transient voltage spike” refers to a sudden, brief increase in voltage above a normal operating level. Transient voltage spikes can be caused by, for example, external voltage events (e.g., shorts between components, unsteady voltage delivery, etc.), switching events (which can draw high currents), electromagnetic interference (EMI), power grid fluctuations, degradation of power supply circuitry, and the like. A “transient response” refers to an output waveform of the circuitry affected by the transient voltage spike, and can be measured as the amount of time for the output waveform to return to a steady state, or a pre-transient voltage spike state.

Many computing components operate with multiphase power. Multiphase power includes multiple power waveforms that are offset from each other (e.g., that each have a different phase). Often, multiphase power is delivered as a balanced waveform, where the power load is evenly distributed across the multiple waveforms. For example, in a three-phase system, the waveforms are often 120 degrees out of phase from each other. Multiphase power can result in smoother power delivery, a reduction in voltage ripple, and overall increased system stability in comparison to single-phase systems. Often, multiphase power systems can deliver relatively high power levels with manageably sized conductors and minimal transmission losses (e.g., electrical components such as inductors and capacitors). This is achieved by distributing the power waveform across multiple phases which has the effect of reducing the current in each waveform while maintaining the full rail-to-rail, (e.g., peak-to-peak) voltage.

Multiphase power circuits can include TLVR circuitry to improve the output generated by the multiphase power circuits. These multiphase TLVR systems output a regulated multiphase waveform. The multiphase power waveform can be a combination of multiple differently phased waveforms that are each produced by a respective phase branch of the multiphase TLVR system. As used herein, “phase branch” refers to a discrete portion of circuitry of the multiphase TLVR power system that is used to generate a single waveform phase. Thus, there can be a phase branch for each phase in a multiphase power waveform. Many multiphase TLVR systems can provide regulated multiphase power to complex processing components, such as central processing units (CPUs), graphics processing units (GPUs), general-purpose GPUs (GPGPUs), data processing units (DPUs), application-specific integrated circuits (ASICs), field-programmable gate arrays (FPGAs), and the like.

Some multiphase TLVR power systems can electromagnetically couple a compensation branch to the phase branches that are used to generate the multiphase power waveform. As used herein, “compensation branch” can refer to one or more electrical components that are electrically coupled in series, and are as a serial group, electromagnetically coupled to the phase branches. Often the compensation branch is electromagnetically coupled to a phase branch through a transformer. Each phase branch can be electrically coupled to a primary winding of a transformer, and the secondary winding of the transformer is electrically coupled to the compensation branch. For example, a primary winding of a transformer can be electrically coupled to a phase branch, and a secondary winding of the same transformer can be electrically coupled to the compensation branch. Due to the design of the transformer, the primary winding and the secondary winding are electromagnetically coupled, which in turn means that the phase branch and the compensation branch are electromagnetically coupled. The compensation branch can include the secondary winding of the transformer, and any other component (e.g., secondary windings of other transformers, etc.) that are electrically coupled to the secondary winding.

In many multiphase TLVR power systems, the compensation branch can function as a large inductor of serially coupled secondary windings. This “large inductor” (e.g., the compensation branch) can be electromagnetically coupled at discrete points to the phase branches (e.g., between each primary winding and corresponding secondary winding). The compensation branch, (e.g., functioning as the large inductor) can concurrently regulate the current across all electromagnetically coupled phase branches. Many multiphase TLVR power systems include an additional compensation inductor, Le in the compensation branch, in addition to the secondary windings of each transformer. The compensation inductor increases the inductance value of the compensation branch to limit the current that passes through the electrically coupled secondary windings, and thus limit the electromagnetic energy that can be transferred from the secondary windings to corresponding primary windings. The compensation inductor can have a relatively large inductance (in comparison to the inductance of the individual secondary coils). When the total inductance of the compensation branch is sufficient, the resistance to changes in current from the large inductance can cause the electromagnetically coupled phase branches to quickly recover from a transient voltage spike.

However, the large fixed-value compensation inductor can also increase the complexity, cost, and footprint of the multiphase TLVR power system. Additionally, during operation of the multiphase TLVR power system, a large fixed-value compensation inductor can require a relatively significant amount of power, and can significantly increase the voltage potential of the multiphase TLVR power system. For example, in many multiphase TLVR power systems, a maximum voltage potential across the compensation inductor can be represented as a sum of the voltage potential for each phase branch of the multiphase TLVR power system. Thus, as the quantity of phase branches increases (e.g., to provide a more consistent power waveform), the size of the compensation inductor and the maximum potential voltage across the compensation inductor can increase significantly. For example, a TLVR with six phase branches that each produce a different phase of a 12-volt waveform can have a maximum voltage potential of 12-volts times six phases, or 72-volts. With a large number of branches (e.g., 20+) these transformers can need to be designed to withstand non-continuous voltage spikes that can be ten or more times the voltage of the waveform produced by the transformer. This can increase the cost to produce a more robust transformer (e.g., the transformer used for generating power waveforms at each phase branch).

Additionally, the high voltage requirement for each transformer can increase the cost and complexity of active or passive cooling elements added to the multiphase TLVR power system. The cooling elements can be designed to dissipate the heat generated by transformers of the multiphase TLVR power system during operation. In some systems, a larger heatsink can be used to dissipate heat generated by transformers receiving a significantly larger voltage than the same transformers operating at a lower voltage. For example, a heatsink for a transformer that produces a 12-volt waveform and can receive a maximum 72-volt waveform can be larger than a heatsink for the same transformer that produces a 12-volt waveform and can receive a maximum 14-volt waveform.

Aspects and embodiments of the disclosure address these and other challenges by providing a multiphase TLVR with transformer compensation. In at least one embodiment, the multiphase TLVR with transformer compensation can modify the primary and/or secondary windings of the transformers coupled to each phase branch to create a large enough inductance on the compensation branch (e.g., the serially coupled secondary windings) to sufficiently restrict current flow to achieve synchronized high-speed transient responses at each phase branch. In at least one embodiment, these modifications can change the K-factor of the transformer (e.g., the transformer harmonic factor). As used herein, “K-factor” refers to the ability of a transformer to withstand harmonic distortion while maintaining a temperature within a certain operating temperature range. In at least one embodiment, the K-factor of each transformer is reduced. When the K-factor is reduced, the harmonic factor of the compensation branch is changed. In at least one embodiment, modification of one or more of the primary windings or the secondary windings of transformers in the multiphase TLVR power system can reduce the size of the compensation inductor, or even entirely eliminate the need for a compensation inductor. In at least one embodiment, while a reduction in the K-factor of the transformer can cause the transformer to operate at higher temperatures in some instances, the net heat generated can be reduced by removing the relatively large compensation inductor.

In at least one embodiment, the inductance of each branch, or in between magnetically coupled branches (e.g., through the compensation branch) can be a variable inductance. Variable inductance can be achieved through, for example, a variable inductance component, such as a variable inductor. By way of non-limiting example, a variable inductor can include one or more of (i) an inductor with a core or winding arrangement that can be manually or electrically adjusted, (ii) a tapped inductor having multiple tap-out connection points, or (iii) a coupling inductor having two or more inductor coils that are related by an adjustable coupling factor. In a particular example, a variable inductance component can be a swinging choke inductor. As used herein, a “swinging choke inductor” or “swinging inductor” is an inductor that has a first inductance L₁ when a current across the swinging inductor is below a threshold current, I_{T}, and a second inductance L₂ when the current across the swinging inductor is above the threshold current (e.g., L₁ for I<I_{T}, or L₂ for I≥I_{T}). That is, the first inductance L₁ corresponds to a first current value below the threshold current I_{T}, and the second inductance L₂ corresponds to a second current value above the threshold current I_{T}. In at least one embodiment, the current through the variable inductor satisfies the threshold current I_{T} when the value of the current through the variable inductor is greater than or equal to the threshold current I_{T}. In at least one embodiment, the current does not satisfy the threshold current I_{T} when the value of the current through the variable inductor is less than the threshold current I_{T}.

Advantages of the disclosure include, but are not limited to, increase in the simplicity of the multiphase TLVR power system, a reduction in the circuit board footprint area of the, a reduction in cost, and/or an increase in the efficiency. Additionally, by removing the large fixed-value inductor, the number of phase branches can be increased significantly in the multiphase TLVR system, as the maximum voltage potential is no longer a 1:1 ratio with the quantity of phase branches. Removal of the large fixed-value inductor can also significantly reduce the power requirements for operating the multiphase TLVR system, which can reduce the complexity of the circuit design, and relax the tolerances for the electrical components.

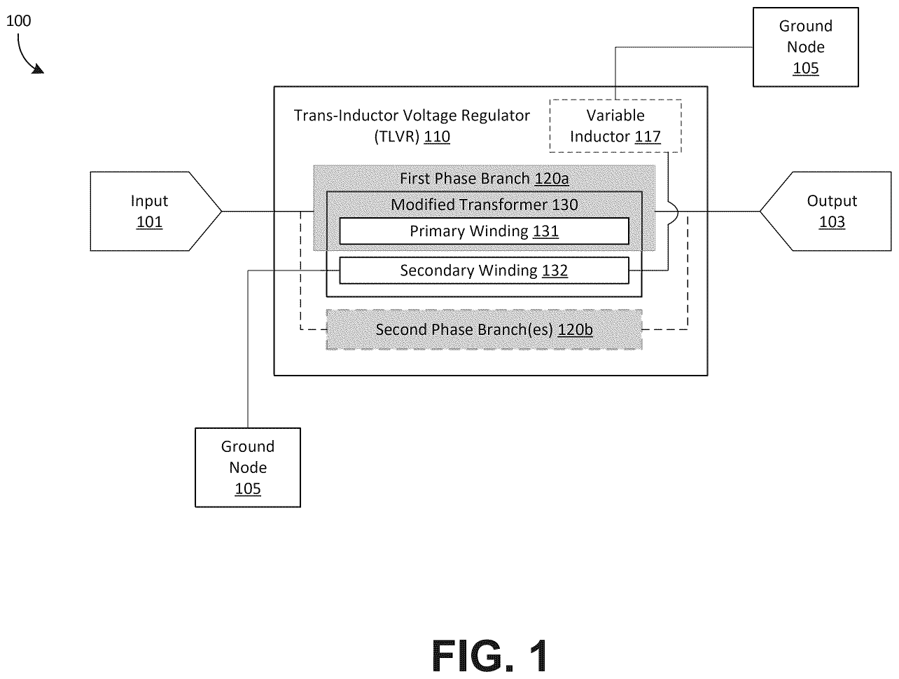

FIG. 1 illustrates a block diagram of an example system 100 for implementing a trans-inductance voltage regulator (TLVR) with transformer compensation, according to at least one aspect of the disclosure. The system 100 includes an input 101, an output 103, and a TLVR 110.

The TLVR 110 includes a modified transformer 130 and a first phase branch 120a. In at least one embodiment, the TLVR 110 includes one or more second phase branch(es) 120b. In at least one embodiment, the one or more second phase branch(es) 120b are the same as, or similar to the first phase branch 120a, and it can be noted that the following description of first phase branch 120a can similarly apply to the one or more second phase branch(es) 120b. In at least one embodiment, the TLVR 110 includes one or more additional transformers (not illustrated). In at least one embodiment, the TLVR 110 includes an optional component, a variable inductor 117 electrically coupled in series between the ground node 105 and the secondary winding 132. In at least one embodiment, the variable inductor 117 can be a swinging inductor as described above, with a first inductance for a first current through the variable inductor 117 and a second inductance for a second current through the variable inductor 117.

The first phase branch 120a receives the input 101 and produces a phased output (e.g., a portion of the output 103). When the TLVR 110 includes the one or more second phase branch(es) 120b, the multiple respective phased outputs can each have a different timing across a given time interval (e.g., different phases). In at least one embodiment, the multiple respective phased outputs from the first phase branch 120a and the one or more second phase branch(es) 120b can be equally divide across a given time interval. In this way, the output power waveform can approach an approximately flat line. For example, the peak of a first phased output can be paired with the trough of a second phased output at time T1, the peak of a third phased output can be paired with the trough of a fourth phased output at time T2, and the peak of a fifth phased output can be paired with the trough of a sixth phased output at time T3. Thus, when summing the six phased outputs, the output waveform (e.g., at the output 103) approaches a flat output at the output 103. The precision and flatness of the waveform at the output 103 increases with each additional phase branch (e.g., the first phase branch 120a, one or more of the second phase branch(es) 120b).

As illustrated, and in at least one embodiment, the first phase branch 120a includes the primary winding 131 of the modified transformer 130. That is, a first terminal of the primary winding 131 can be electrically coupled to circuitry of the first phase branch 120a, and a second terminal of the primary winding 131 can also be electrically coupled to circuitry of the first phase branch 120a. In at least one embodiment, the first phase branch 120a includes additional circuitry, such as one or more of inductors, capacitors, resistors, logic gates, transistors, delay components, phase-change components, or the like (not illustrated).

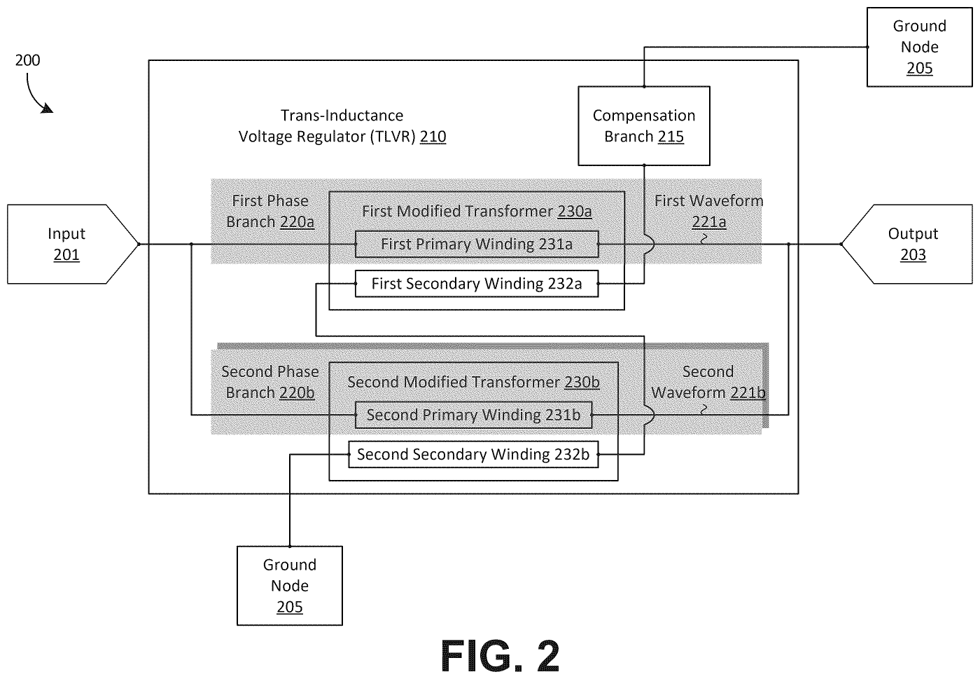

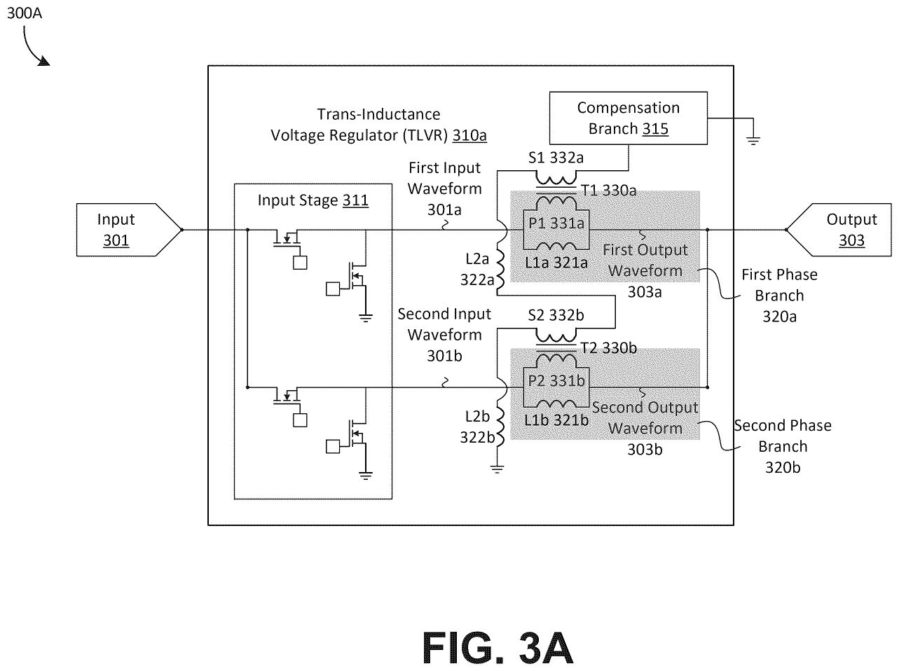

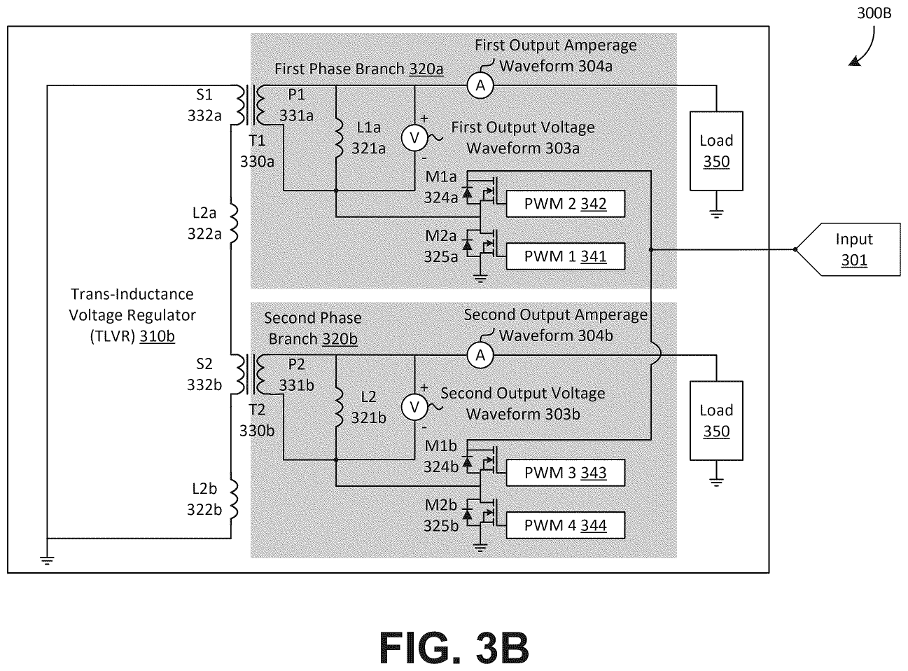

The primary winding 131 of the modified transformer 130 is electromagnetically coupled to the secondary winding 132. As illustrated, and in at least one embodiment, the secondary winding 132 is not included in the first phase branch 120a. That is, neither a first terminal or a second terminal of the secondary winding 132 is electrically coupled to circuitry of the first phase branch 120a (or any other phase branch, e.g., the one or more second phase branch(es) 120b). In embodiments where the TLVR 110 includes the one or more second phase branch(es) 120b, the secondary winding of each modified transformer in the TLVR 110 are respectively electrically coupled to the variable inductor 117 and together in series to form a compensation branch (not illustrated). Additional details regarding the phase branches (e.g., first phase branch 120a and one or more second phase branch(es) 120b) and the compensation branch are described below with reference to FIG. 2 and FIGS. 3A-B.

In at least one embodiment, the modified transformer 130 has certain inductances for the primary winding 131 and the secondary winding 132. In some embodiments, the modified transformer 130 has a certain K-factor (e.g., certain transformer harmonic factor). In at least one embodiment, the K-factor of the modified transformer 130 can be reduced, such that the modified transformer 130 is less able to withstand harmonic distortion. In at least one embodiment, a K-factor of the modified transformer 130 can be between approximately 0.7 and approximately 0.9 (e.g., ˜0.7≤K≤˜0.9). In at least one embodiment, one or more active or passive components are electrically coupled to one or more of the primary winding 131 or the secondary winding 132 to cause the modified transformer 130 (or the circuitry electrically coupled to the modified transformer 130) to have a certain K-factor value (e.g., certain harmonic factor).

In at least one embodiment, the TLVR 110 includes a variable inductor 117 coupled between the secondary winding 132 and the ground node 105 (e.g., coupled to the compensation branch of the TLVR 110, not illustrated). In at least one embodiment, the variable inductor 117 can be a variable-induction component. As described above, the variable inductor 117 can have a first inductance L₁ when a current across the variable inductor 117 is below a threshold current, I_{T}, and a second inductance L₂ when a current across the variable inductor 117 is above the threshold current (e.g., L₁ for I<I_{T}, or L₂ for I≥I_{T}). In at least one embodiment, when the current across the variable inductor 117 is low, the inductance L₁ is high, and when the current across the variable inductor 117 is high, the inductance L₂ is low. In at least one embodiment, the threshold current I_{T} is based on physical properties of the variable inductor 117, and is selected during design and production of the TLVR 110. In at least one embodiment, the threshold current I_{T} can be changed by activating or deactivating certain portions of a circuit connected to the variable inductor 117. In at least one embodiment, the inductance L₁ and the inductance L₂ are similarly based on physical properties of the variable inductor 117 and are also selected during design and production of the TLVR 110.

FIG. 2 illustrates a block diagram of an example system 200 for implementing a trans-inductance voltage regulator (TLVR) with transformer compensation, according to at least one aspect of the disclosure. The system 200 includes an input 201, an output 203, a ground node 205, and a TLVR 210.

The TLVR 210 includes a compensation branch 215, a first phase branch 220a, a first modified transformer 230a, a second phase branch 220b, and a second modified transformer 230b. In at least one embodiment, the TLVR 210 includes additional phase branches, illustrated in FIG. 2 with the dark gray box behind second phase branch 220b. In at least one embodiment, each phase branch includes the same, or similar components and/or circuitry and performs the same, or similar functions or operations. Thus, it can be appreciated that a description of one of the phase branches (e.g., the first phase branch 220a or the second phase branch 220b) can similarly apply to other phase branches (e.g., the first phase branch 220a, the second phase branch 220b, or other phase branches that are not illustrated).

The TLVR 210 receives the input 201 (e.g., a power waveform from a power source) and provides the input 201 to the first phase branch 220a and the second phase branch 220b. The first phase branch 220a produces a first waveform 221a having a first phase. The second phase branch 220b produces a second waveform 221b having a second phase. In at least one embodiment, the first phase of the first waveform 221a is different from the second phase of the second waveform 221b. In at least one embodiment, the phase of the first waveform 221a is opposing to the phase of the second waveform 221b. For example, the phase of the first waveform 221a can be 0 degrees, and the phase of the second waveform 221b can be 180 degrees. In another example, the first waveform 221a can peak at times T₁, T₃, T₅, etc., and the second waveform 221b can peak at times T₂, T₄, T₆, etc., and thus at an integer of time T_{I}, either the first waveform 221a or the second waveform 221b will have a peak.

In at least one embodiment, one or more of the first waveform 221a or the second waveform 221b is a full-wave waveform. As used herein, “full-wave waveform” refers to a waveform having both the positive and negative cycles of a waveform. For example, a sinusoidal waveform is a full-wave waveform. In at least one embodiment, one or more of the first waveform 221a or the second waveform 221b is a half-wave waveform. As used herein, “half-wave waveform” refers to a waveform having either the positive or the negative cycle of the waveform. For example, one half of a sinusoidal waveform (e.g., the top half or the bottom half) is a half-waveform. In at least one embodiment, one or more of the first waveform 221a or the second waveform 221b is a rectified waveform. As used herein, “rectified waveform” refers to a waveform where some of all of the negative cycles of the waveform are converted to positive cycles. For example, a sinusoidal waveform where the negative cycles have been flipped across the X-axis to resemble positive cycles (e.g., resembling a series of “bumps”) is a rectified waveform.

In at least one embodiment, the phases of the first waveform 221a and the second waveform 221b are selected to cancel out the peaks and valleys of each waveform. For example, if the first waveform 221a has a peak at time T1, the phase of the second waveform 221b can be selected such that the second waveform 221b has a valley at time T1. When combined, the peak of the first waveform 221a and the valley of the second waveform 221b add together to produce a relatively flat response approximating a direct-current (DC) supply at output 203. For example, and in at least one embodiment, the TLVR includes a third phase branch (not illustrated), and each waveform (e.g., first waveform 221a, second waveform 221b, third waveform (not illustrated) can have a phase that is separated by 120 degrees from the next phase (e.g., 360 degrees divided by the number of phase branches).

In at least one embodiment, the first phase branch 220a includes a first primary winding 231a of the first modified transformer 230a. That is, a first terminal of the first primary winding 231a is electrically coupled to circuitry of the first phase branch 220a, and a second terminal of the first primary winding 231a is also electrically coupled to circuitry of the first phase branch 220a. In at least one embodiment, the first phase branch 220a includes additional circuitry, such as one or more of inductors, capacitors, resistors, logic gates, transistors, delay components, phase-change components, or the like (not illustrated). The first primary winding 231a of the first modified transformer 230a is magnetically coupled to the first secondary winding 232a. The second phase branch 220b similarly includes the second primary winding 231b of the second modified transformer 230b.

In at least one embodiment, a first secondary winding 232a of the first modified transformer 230a is not included in the first phase branch 220a. That is, neither a first terminal nor a second terminal of the first secondary winding 232a is electrically coupled to circuitry of the first phase branch 220a. The second secondary winding 232b of the second modified transformer 230b is similarly not electrically coupled to the second phase branch 220b (or any other phase branch (not illustrated)).

In at least one embodiment, the first terminal of the first secondary winding 232a is electrically coupled to a compensation branch 215, and the second terminal of the first secondary winding 232a is electrically coupled to a first terminal of the second secondary winding 232b (e.g., electrically coupled in series). In at least one embodiment, the compensation branch is coupled between the first secondary winding 232a and the ground node 205. The second secondary winding 232b can further electrically coupled in series to the ground node 205. In at least one embodiment, one or more active or passive electrical components are electrically coupled in series between the first secondary winding 232a and the second secondary winding 232b. In embodiments where the TLVR 210 includes multiple phase branches corresponding to modified transformers (not illustrated), respective secondary windings of each modified transformer are similarly electrically coupled in series between the compensation branch 215 and the ground node 205 (e.g., serially coupled with the first secondary winding 232a and the second secondary winding 232b).

In at least one embodiment, during operation the TLVR 210 receives a waveform from input 201 at the primary winding(s) (e.g., first primary winding 231a and second primary winding 231b) of the modified transformer(s) (e.g., first modified transformer 230a and second modified transformer 230b). The waveform passes through the primary winding(s), which magnetically induce a current onto the compensation branch (e.g., the compensation branch 215) through the respective secondary winding(s) (e.g., first secondary winding 232a and second secondary winding 232b). In at least one embodiment, the current that is electromagnetically induced onto the compensation branch 215 can determine one or more characteristics of the first waveform 221a and the second waveform 221b. In at least one embodiment, the compensation branch 215 can control or determine a particular characteristic of the output waveforms (e.g., the first waveform 221a or the second waveform 221b), such as for example current ripple, while not controlling another characteristic of the output waveforms, such as waveform phase. Thus, the output waveforms can produce independent waveforms (e.g., waveforms with different phases) that still maintain similar characteristics (e.g., current ripple tolerances, peak-to-peak voltages, impedance value, or the like).

In at least one embodiment, the compensation branch 215 is made up of the series of coupled secondary windings (e.g., first secondary winding 232a, second secondary winding 232b) and can function as to uniformly regulate the electromagnetically coupled phase branches (e.g., through the electromagnetic coupling between primary windings and secondary windings of respective transformers). In at least one embodiment, the first modified transformer 230a (in connection with the additional included transformers such as the second modified transformer 230b) allow the compensation branch 215 to effectively regulate the waveforms produced by each phase branch without a dedicated compensation component. In at least one embodiment, one or more smaller passive or active electrical components can be coupled in series to the compensation branch 215.

FIG. 3A illustrates a circuit diagram of an example circuit 300A for implementing a trans-inductance voltage regulator (TLVR) with transformer compensation, according to at least one aspect of the disclosure. The circuit 300A includes an input 301, an output 303, and a TLVR 310a.

The TLVR 310a includes an input stage 311 and a compensation branch 315. In at least one embodiment, the input stage 311 separates the input 301 into multiple waveforms (e.g., first input waveform 301a and second input waveform 301b). In at least one embodiment, the input stage 311 pre-processes the input 301 to produce one or more conditioned or pre-processed inputs (e.g., first input waveform 301a or second input waveform 301b). In at least one embodiments, the input stage 311 includes one or more of switching components, delay components, phase-change components, circuit logic components, active components, or the like. In at least one embodiment, the first input waveform 301a has the same phase as the first output voltage waveform 303a, and similarly, the second input waveform 301b has the same phase as the second output voltage waveform 303b. That is, in at least one embodiment, the input stage 311 changes the phases of each waveform that is provided to the phase branches.

In at least one embodiment, one or more phase branches (e.g., the first phase branch 320a or the second phase branch 320b) receive input waveforms (e.g., first input waveform 301a or second input waveform 301b) from the input stage 311. In at least one embodiment, each phase branch includes one or more active or passive circuit elements. In at least one embodiment, each phase branch includes a primary winding (e.g., first primary winding “P1” 331a or second primary winding “P2” 331b) of a transformer e.g., first transformer “T1” 330a or second transformer “T2” 330b). That is, a primary winding of a transformer is electrically coupled to circuitry of a phase branch. For example, a first terminal of primary winding 331a can be electrically coupled to one or more first active or passive circuit elements of the first phase branch 320a, and a second terminal of the primary winding 331a can be electrically coupled to one or more second active or passive circuit elements of the first phase branch 320a.

In at least one embodiment, each phase branch generates an output waveform (e.g., the first output voltage waveform 303a or the second output voltage waveform 303b) based on the input waveform received from the input stage 311. In at least one embodiment, each phase branch generates an output waveform that has certain characteristics, such as a certain peak-to-peak voltage, a certain amperage, a certain power value, a certain phase, or the like. In at least one embodiment, the phase branches can perform impedance matching between the input stage 311 and the output 303. In at least one embodiment, the outputs of each phase branch (e.g., first phase branch 320a and second phase branch 320b) are connected at an output node (not illustrated) to produce a power output waveform at output 303. In at least one embodiment, additional components, including active or passive components, or circuit logic can combine the outputs of each phase branch.

In at least one embodiment, the compensation branch 315 is electromagnetically coupled to one or more phase branches. As used herein, “compensation branch” can refer to all components that are electrically coupled to the secondary windings (e.g., the first secondary winding “S1” 332a or the second secondary winding “S2” 332b) of the transformers (e.g., the first transformer 330a or the second transformer 330b) of the TLVR (e.g., the TLVR 310a). When a primary winding receives a waveform, due to the electromagnetic coupling between the primary winding and the paired secondary winding in the transformer, electromagnetic energy is transferred from the primary winding to the secondary winding. In at least one embodiment, the primary winding (e.g., first primary winding 331a) transfers electromagnetic energy to the compensation branch 315 when a voltage potential is applied to the primary winding. Similarly, in at least one embodiment, when a voltage potential is applied to a secondary winding (e.g., first secondary winding 332a), electromagnetic energy is transferred to the primary winding (e.g., first primary winding 331a).

In at least one embodiment, the transfer of energy (through electrical couplings and electromagnetic couplings) in the TLVR 310a can be based in part on the harmonics factor of the TLVR 310a as a whole. In at least one embodiment the harmonic factor of the TLVR 310a can be based in large part on the harmonic factors of the compensation branch 315 and the respective harmonic factors of the phase branches (e.g., first phase branch 320a, second phase branch 320b, etc.).

When a voltage potential is applied across the first primary winding 331a, energy is transferred (e.g., as electromagnetic energy) from the first primary winding 331a to the electromagnetically coupled first secondary winding 332a, which is electrically coupled in series with the compensation branch 315. Similarly, second primary winding 331b can transfer electromagnetic energy to the secondary winding 332b, which is similarly electrically coupled in series with the compensation branch 315.

In at least one embodiment, the first primary winding 331a is coupled in parallel with one or more electrical components of the first phase branch 320a. In at least one embodiment, those one or more electrical components include at least a first branch inductor “L1a” 321a. Similarly, the second primary winding 331b is coupled in parallel with one or more components of the second phase branch 320b, including at least the second branch inductor “L1b” 321b. In at least one embodiment, the first branch inductor 321a and the second branch inductor 321b are merely illustrative representations in FIG. 3A that represent the inductance values of the first primary winding 331a and the second primary winding 331b, respectively (e.g., the actual circuit may not physically include the first branch inductor 321a and the second branch inductor 321b).

In at least one embodiment, the first secondary winding 332a is serially coupled with a first series inductor “L2a” 322a. Similarly, the second secondary winding 332b can be serially coupled with the second series inductor “L2b” 322b. These inductors (e.g., the first series inductor 322a and the second series inductor 322b) can be relatively small inductors, and can be included in between each secondary winding that is serially coupled to the compensation branch 315. In at least one embodiment, the first series inductor 322a and the second series inductor 322b are merely illustrative representations in FIG. 3A that represent the inductance values of the first primary winding 331a and the second primary winding 331b, respectively (e.g., the actual circuit may not physically include the first series inductor 322a and the second series inductor 322b).

In at least one embodiment, the values of first branch inductor 321a (similarly, the second branch inductor 321b) and the first series inductor 322a (similarly, the second series inductor 322b) can be changed to affect the K-factor of the respective transformer (e.g., the first transformer 330a and the second transformer 330b, respectively). In at least one embodiment, the harmonic factor of the first phase branch 320a is related to the K-factor of the first transformer 330a. In at least one embodiment, the K-factor of each transformer in the TLVR 310a (e.g., second transformer 330b, etc.) is the same. As described above, and in at least one embodiment, the K-factor of the first transformer 330a can be based on an inductance value of the first primary winding 331a and an inductance value of the first secondary winding 332a.

In at least one embodiment, modifying the harmonic factor of each phase branch (e.g., by altering the K-factor of each transformer), the inductance value of the compensation branch 315 is altered. In at least one embodiment, the secondary windings of the transformers in the TLVR 310a are modified sufficiently to satisfy the induction value threshold for the compensation branch 315 without use of an additional inductor (e.g., compensation inductor).

In at least one embodiment, a mathematical relationship exists between serial inductive components of the compensation branch 315 (e.g., the first series inductor 322a and the second series inductor 322b), and branch inductive components of each phase branch (e.g., the first branch inductor 321a and the second branch inductor 321b). The following equation shows at least one example or a mathematical relationship between the various inductive components of the TLVR 310a.

$$\frac{{L}_{comp}}{{N}_{branches}} = ( \frac{{L}_{series} \times {L}_{branch}}{{L}_{series} + {L}_{branch}} + {L}_{branch} )$$

(L_{branch}) represents the values of the branch inductive components (e.g., first branch inductor 321a, second branch inductor 321b, etc.).
(Lₛₑᵣᵢₑₛ) represents the values of the serial inductive components (e.g., first series inductor 322a, second series inductor 322b, etc.).
(N_{branches}) represents the total number of phase branches (e.g., first phase branch 320a, second phase branch 320b, etc.).
(L_{comp}) represents the inductance value of the compensation branch 315. In at least one embodiment, (L_{comp}) is a pre-selected value based on one or more performance metrics of the TLVR 310a. In at least one embodiment, (L_{comp}) represents a threshold inductance value for the compensation branch. That is, (L_{comp}) can be a minimum inductance value for the TLVR 310a to meet one or more performance metrics.

As described above, in at least one embodiment, the (L_{branch}) inductance value(s) are incorporated into the design of the first primary winding 331a of the first transformer 330a (and similarly, the second primary winding 331b of the second transformer 330b). For example, the first primary windings 331a can be designed to have an inductance value equal to the inductance value needed for (L_{branch}). In at least one embodiment, the (L_{branch}) inductance value(s) are achieved by adding electrical components (e.g., inductors, active components, passive components, etc.) to the first phase branch 320a. For example, as illustrated in FIG. 3A, the first branch inductor 321a is coupled to the first primary winding 331a in parallel.

In at least one embodiment, the (Lₛₑᵣᵢₑₛ) inductance value(s) can be incorporated into the design of the first secondary winding 332a of the first transformer 330a (and similarly, the second secondary winding 332b of the second transformer 330b). For example, the first secondary windings 332a can be designed to have an inductance value equal to the inductance value needed for (Lₛₑᵣᵢₑₛ). In at least one embodiment, the (Lₛₑᵣᵢₑₛ) inductance value(s) are achieved by adding electrical components (e.g., inductors, active components, passive components, etc.) between serially coupled secondary windings. For example, as illustrated in FIG. 3A, the first series inductor 322a is serially coupled between the first secondary winding 332a and the second secondary winding 332b.

In at least one embodiment, one or more of the (L_{branch}) values (e.g., the inductance value(s) of the first branch inductor 321a or the second branch inductor 321b) or the (Lₛₑᵣᵢₑₛ) values (e.g., the inductance value(s) of the first series inductor 322a or the second series inductor 322b) can be a variable inductance (e.g., using a variable inductor, such as a swinging inductor not illustrated). In at least one embodiment, the swinging inductor can have a high inductance value when a first current through the swinging inductor is low, and a low inductance value when a second current through the swinging inductor is high (e.g., where the second current>first current). In an alternative embodiment, the swinging inductor can have a low inductance value when a first current through the swinging inductor is low, and a high inductance value when a second current through the swinging inductor is high (e.g., where the first current>second current).

FIG. 3B illustrates a circuit diagram of an example of an alternative circuit 300B for implementing a trans-inductance voltage regulator (TLVR) with transformer compensation, according to at least one aspect of the disclosure. The circuit 300B includes an input 301, outputs (represented as first output voltage waveform 303a and second output voltage waveform 303b), and a TLVR 310b. It can be noted that the components of the TLVR 310b can be the same as, or similar to the components of the TLVR 310a, except as otherwise described. For example, the first primary winding 331a of the TLVR 310b can be the same as or similar to the first primary winding 331a of the TLVR 310a.

The alternative circuit 300B receives input 301 and generates the first output voltage waveform 303a and the first output amperage waveform 304a. Similarly, the alternative circuit 300B generates the second output voltage waveform 303b and the second output amperage waveform 304b. In some embodiments, the first output amperage waveform 304a and the first output voltage waveform 303a can be balanced by one or more components that are coupled between the respective waveforms and the load 350. In some embodiments, the load 350 can represent one or more processors that receive power from the TLVR circuit (e.g., the alternative circuit 300B). In some embodiments, the first output amperage waveform 304a is dependent on the first output voltage waveform 303a. That is, the first output voltage waveform 303a can be generated to meet one or more criteria, and the first output amperage waveform 304a can be the resulting amperage waveform (e.g., voltage-driven output). In some embodiments, the first output voltage waveform 303a is dependent on the first output amperage waveform 304a. That is, the first output amperage waveform 304a can be generated to meet one or more criteria, and the first output voltage waveform 303a can be the resulting voltage waveform (e.g., amperage-driven output). The waveforms of the second phase branch 320b (e.g., second output voltage waveform 303b and second output amperage waveform 304b) can be similarly generated and used.

The TLVR 310b receives an input waveform from input 301. The input waveform can be controlled by a series of timed pulse-width modulation (PWM) signals received at switching components, such as transistors. In at least one embodiment, the timing of the PWM signals for the TLVR 310b are controlled by a modulation controller (not illustrated). In at least one embodiment, the input waveform for each branch (e.g., first phase branch 320a or second phase branch 320b) is controlled by two PWM signals (e.g., PWM_1 341 and PWM_2 342, or PWM_3 343 and PWM_4 344, respectively). That is, in at least one embodiment, the PWM signals control the phase of the waveform produced by each branch (e.g., at the first output voltage waveform 303a, or the second output voltage waveform 303b, respectively). In at least one embodiment, the PWM signals are received by respective metal-oxide-semiconductor field-effect transistors (MOSFETs) (e.g., “M1a” MOSFET 324a and “M2a” MOSFET 325a, or “M1b” MOSFET 325b and “M2b” MOSFET 325b, respectively).

Each phase branch (e.g., first phase branch 320a and second phase branch 320b) can include additional active or passive components to pre-process or condition the waveform received by the primary coil (e.g., the first primary winding 331a or the second primary winding 331b).

In at least one embodiment, components in each phase branch can include one or more branch inductors. In at least one embodiment, a first branch inductor “L1a” is electrically coupled in parallel with the first primary winding 331a.

The secondary windings of each transformer (e.g., first transformer “T1” 330a and second transformer “T2” 330b) can be coupled in series. In at least one embodiment, one or more additional components can be coupled to the secondary windings of each transformer. In at least one embodiment, components coupled to secondary windings of each transformer can include an inductor (e.g., series inductor “L2a” 322a).

As described above with reference to FIG. 3A, and in at least one embodiment, a relationship between the inductance of the phase branch and the inductance of the serially coupled secondary windings can affect one or more characteristics of the output waveforms from each phase branch (e.g., the first output voltage waveform 303a or the second output voltage waveform 303b). In at least one embodiment a plurality of harmonic factors corresponding to respective phase branches can affect a current value of the output waveform. In at least one embodiment, a transformer harmonic factor (e.g., K-factor) can affect the harmonic factor of a phase branch.

It can be noted that while only two phase branches are depicted in FIG. 3B, the TLVR 310b can include multiple phase branches. In at least one embodiment, the TLVR 310b includes twenty or more phase branches. In at least one embodiment, a slew rate of the TLVR 310b can be increased by increasing the number of phase branches.

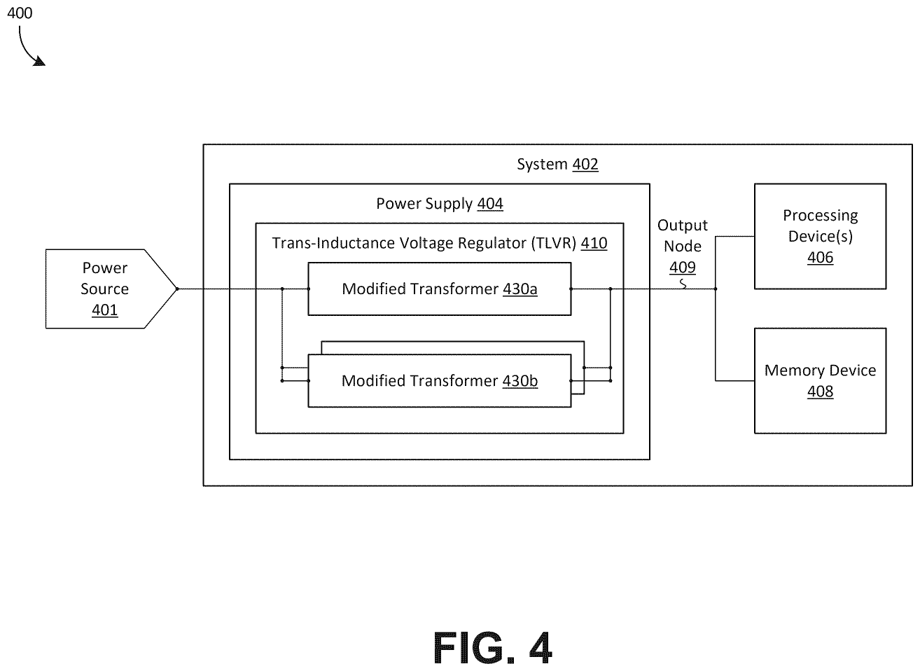

FIG. 4 illustrates a block diagram of an example environment 400 for implementing a trans-inductance voltage regulator (TLVR) with transformer compensation in a system (e.g., system 402), according to at least one aspect of the disclosure. The environment 400 includes a power source 401 and a system 402.

The system 402 includes a power supply 404, a processing device 406 (e.g., one or more processing devices), a memory device 408, and an output node 409. In at least one embodiment, the system 402 can include additional electrical components, processing components, or other circuitry. The power supply 404 receives input from the power source 401, and provides an output (e.g., regulated power waveforms) to the processing device 406 and the memory device 408.

In at least one embodiment, the power supply 404 includes a TLVR 410, which includes a first modified transformer 430a and a second modified transformer 430b. Additional modified transformers are considered, as indicated by the illustrated box behind the second modified transformer 430b in FIG. 4. The TLVR 410, including the first modified transformer 430a and the second modified transformer 430b can be the same as or similar to one or more of the modified transformer 130 of the TLVR 110 in FIG. 1, the first modified transformer 230a or the second modified transformer 230b of the TLVR 210 in FIG. 2, or the first transformer 330a or the second transformer 330b of the TLVR 310a in FIG. 3A or the TLVR 310b in FIG. 3B.

In at least one embodiment, the processing device 406 can include one or more of a central processing unit (CPU), a graphics processing unit (GPU), a data processing unit (DPU), an application-specific integrated circuit (ASIC), such as Tensorflow® Processing Unit from Google, an inference processing unit (IPU) from Graphcore™, or a Nervana® (e.g., “Lake Crest”) processor from Intel Corp or the like. In at least one embodiment, the processing device 406 can be a machine-learning specific chip architecture used for training a machine learning model and/or using a trained machine learning model. In at least one embodiment, the processing device 406 can be an embedded processing device such as a microcontroller, a field programmable gate array (FPGA), a digital signal processor (DSP), an analog-to-digital converter (ADC) or any other system that can perform one or more similar functions.

In at least one embodiment, the memory device 408 can be a volatile or non-volatile memory device. For example, a volatile memory device can include, without limitation, a Dynamic Random Access Memory (DRAM) device or a Static Random Access Memory device (SRAM). Further, a non-volatile memory device can include a flash memory device, or a hard disk drive (HDD) memory device.

In at least one embodiment, the system 402 is a game console, including a game and media console, a mobile gaming console, a handheld came console or an online game console. In at least one embodiment, the system 402 is a handheld device, such as in a mobile phone, smartphone, tablet computing device, a mobile Internet device, or a digital camera. In at least one embodiment, the system 402 a wearable device, such as a smart watch wearable device, smart eyewear device, augmented reality device, or virtual reality device. In at least one embodiment, the system 402 is a television or set-top box device.

In at least one embodiment, the system 402 is implemented in a computer networking, or datacenter environment. In at least one embodiment, the system 402 is implemented in a system incorporating one or more virtual machines (VMs). In at least one embodiment, the system 402 is implemented in a cloud-computing system, or a system at least partially using cloud computing resources. In at least one embodiment, the system 402 is implemented in an edge device (e.g., a computing device that operates at the “edges” of a network, near network end-users). In at least one embodiment, the system 402 is implemented in a system for creation and/or distribution of collaborative content (e.g., a collaborative content platform). The system 402 can be configured to connect to a local area network (LAN), wide area network (WAN), a wired network (e.g., Ethernet network), a wireless network (e.g., an 802.11 network or wireless fidelity (Wi-Fi) network, a Bluetooth instance between connected devices, etc.), a cellular network (e.g., a Long Term Evolution (LTE) network), routers, hubs, switches, server computers, and/or a combination thereof. In at least one embodiment, the system 402 can be implemented in high-speed intra datacenter communication networking, including optical communication networking (e.g., using fiber optical communication standards).

In at least one embodiment, the system 402 is a high-speed or high-bandwidth data communication systems. For example, the system 402 can be a system designed to communicate over a Peripheral Component Interconnect Express (PCIe) bus (including versions 1.0-7.0, etc.), an Inter-Integrated Circuit (I2C) bus, a System Management Bus (SMBus), a Low Pin Count (LPC) bus, a Serial Peripheral Interface (SPI), a High Definition Audio (HAD) bus, a Serial Advance Technology Attachment (SATA) bus, a Universal Serial Bus (USB) (including versions 1.0-4.0) or a Universal Asynchronous Receiver/Transmitter (UART) bus. In at least one embodiment, the system 402 can be implemented in a System on a Chip (SoC).

In at least one embodiment, the system 402 can be implemented in a control system for an autonomous or a semi-autonomous machine. In at least one embodiment, the system 402 can be implemented in a perception system (e.g., vision system, sensing system, etc.) for an autonomous or semi-autonomous machine. In at least one embodiment, the system 402 can be implemented in automotive systems, such as advanced driver-assistance systems (ADAS), inter- and intra-vehicle communication networks, etc. In at least one embodiment, the system 402 can be implemented in a robot, or robotic machine. For example, and in at least one embodiment, the system 402 can be implemented in one or more of, for example, a control system, a perception system, a decision system, a navigation system, a motor control system, or the like in a robot or robot-like machine.

In at least one embodiment, the system 402 is used to power components of a system for performing one or more of machine-learning training or inference operations including neural network and deep learning operations, training input data collection or synthesis, machine learning input pre-processing, machine learning output post-processing, or the like. In at least one embodiment, the system 402 can be implemented in a system for performing simulation operations. In at least one embodiment, the system 402 is used to power components for performing machine-learning or inference operations in a simulation. In at least one embodiment, the system 402 is used for systems that generate synthetic assets such as, for example synthetic data, single-dimensional data, multi-dimensional assets, or the like.

### Computer Systems

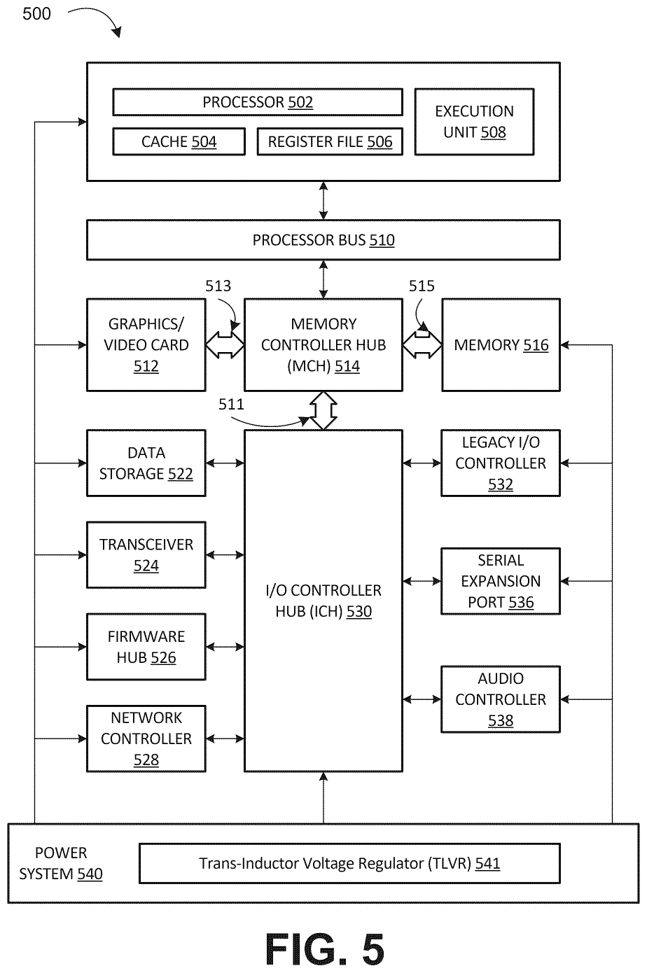

FIG. 5 is a block diagram illustrating an exemplary computer system, such as computer system 500, which can be a system with interconnected devices and components, a system-on-a-chip (SOC), or some combination thereof, according to aspects of the disclosure. In at least one embodiment, computer system 500 can include, without limitation, a component, such as a processor 502, to employ execution units including logic to perform algorithms for process data, in accordance with the present disclosure, such as in the embodiments described herein. In at least one embodiment, computer system 500 can include processors, such as PENTIUM® Processor family, Xcon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) can also be used. In at least one embodiment, computer system 500 can execute a version of WINDOWS' operating system available from Microsoft Corporation of Redmond, Wash., although other operating systems (UNIX and Linux, for example), embedded software, and/or graphical user interfaces, can also be used.

Embodiments can be used in other devices such as handheld devices and embedded applications. Some examples of handheld devices include cellular phones, Internet Protocol devices, digital cameras, personal digital assistants (PDAs), and handheld PCs. In at least one embodiment, embedded applications can include a microcontroller, a digital signal processor (DSP), a system on a chip, network computers (NetPCs), set-top boxes, network hubs, wide area network (WAN) switches, or any other system that can perform one or more instructions in accordance with at least one embodiment.

In at least one embodiment, one or more of the components of the computer system 500 can be powered by a power system 540 including a TLVR 541. For example, the power system 540 can be included in a power supply (not illustrated) of the computer system 500, or at the output from the power supply for the computer system 500. The power system 540 can be the same as, or similar to the system 402 described above with reference to FIG. 4.

In at least one embodiment, the power system 540 can be representative of distinct power circuitry included in one or more of the components of the computer system 500. For example, the processor 502 can have power circuitry that includes a TLVR 541 with transformer compensation as described herein (e.g., a power system 540) for powering the processor 502. In another example, the graphics/video card 512 can have power circuitry that includes a TLVR 541 with transformer compensation as described herein (e.g., a power system 540) for powering the graphics/video card 512.

In at least one embodiment, computer system 500 can include, without limitation, processor 502 that can include, without limitation, one or more execution units 508 to perform operations according to techniques described herein. In at least one embodiment, computer system 500 is a single-processor desktop or server system, but in another embodiment, the computer system 500 can be a multiprocessor system. In at least one embodiment, processor 502 can include, without limitation, a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. In at least one embodiment, processor 502 can be coupled to a processor bus 510 that can transmit data signals between processor 502 and other components in computer system 500.

In at least one embodiment, processor 502 can include, without limitation, a Level-1 (L1) internal cache memory (cache) cache 504. In at least one embodiment, processor 502 can have a single internal cache or multiple levels of internal cache. In at least one embodiment, the cache memory can reside external to processor 502. Other embodiments can also include a combination of both internal and external caches depending on particular implementation and needs. In at least one embodiment, register file 506 can store different types of data in various registers, including and without limitation, integer registers, floating-point registers, status registers, and instruction pointer registers.

In at least one embodiment, an execution unit 508, including and without limitation, logic to perform integer and floating-point operations, also reside in processor 502. In at least one embodiment, processor 502 can also include a microcode (ucode) read-only memory (ROM) that stores microcode for certain macro instructions. In one or more embodiments, many multimedia applications can be accelerated and executed more efficiently by using the full width of a processor's data bus for performing operations on packed data, which can eliminate the need to transfer smaller units of data across the processor's data bus to perform one or more operations one data element at a time.

In at least one embodiment, execution unit 508 can also be used in microcontrollers, embedded processors, graphics devices, DSPs, and other types of logic circuits. In at least one embodiment, computer system 500 can include, without limitation, a memory 516. In at least one embodiment, memory 516 can be implemented as a Dynamic Random Access Memory (DRAM) device, a Static Random Access Memory (SRAM) device, a flash memory device, or other memory devices. In at least one embodiment, memory 516 can store instruction(s) and/or data represented by data signals that can be executed by processor 502.

In at least one embodiment, the system logic chip can be coupled to processor bus 510 and memory 516. In at least one embodiment, the system logic chip can include, without limitation, a memory controller hub (MCH), such as MCH 514, and processor 502 can communicate with MCH 514 via processor bus 510. In at least one embodiment, MCH 514 can provide a high bandwidth memory path 515 to memory 516 for instruction and data storage and for storage of graphics commands, data, and textures. In at least one embodiment, MCH 514 can direct data signals between processor 502, memory 516, and other components in computer system 500 and bridge data signals between processor bus 510, memory 516, and a system input/output (I/O) 511. In at least one embodiment, a system logic chip can provide a graphics port for coupling to a graphics controller. In at least one embodiment, MCH 514 can be coupled to memory 516 through a high bandwidth memory path 515, and graphics/video card 512 can be coupled to MCH 514 through an Accelerated Graphics Port (AGP) interconnect 513.

In at least one embodiment, computer system 500 can use the system I/O 511 that is a proprietary hub interface bus to couple the MCH 514 to I/O controller hub (ICH), such as ICH 530. In at least one embodiment, ICH 530 can provide direct connections to some I/O devices via a local I/O bus. In at least one embodiment, a local I/O bus can include, without limitation, a high-speed I/O bus for connecting peripherals to memory 516, chipset, and processor 502. Examples can include, without limitation, data storage 522, a transceiver 524, a firmware hub (flash Basic Input/Output System (BIOS)) 526, a network controller 528, a legacy I/O controller 532, a serial expansion port 536, such as Universal Serial Bus (USB), and an audio controller 538. In at least one embodiment, data storage 522 can include a hard disk drive, a floppy disk drive, a compact disc read-only memory (CD-ROM) device, a flash memory device, or other mass storage devices.

In at least one embodiment, FIG. 5 illustrates a computer system 500, which includes interconnected hardware devices or “chips,” whereas, in other embodiments, FIG. 5 can illustrate an exemplary System on a Chip (SoC). In at least one embodiment, devices can be interconnected with proprietary interconnects, standardized interconnects (e.g., PCIe), or some combination thereof. In at least one embodiment, one or more components of computer system 500 are interconnected using compute express link (CXL) interconnects.

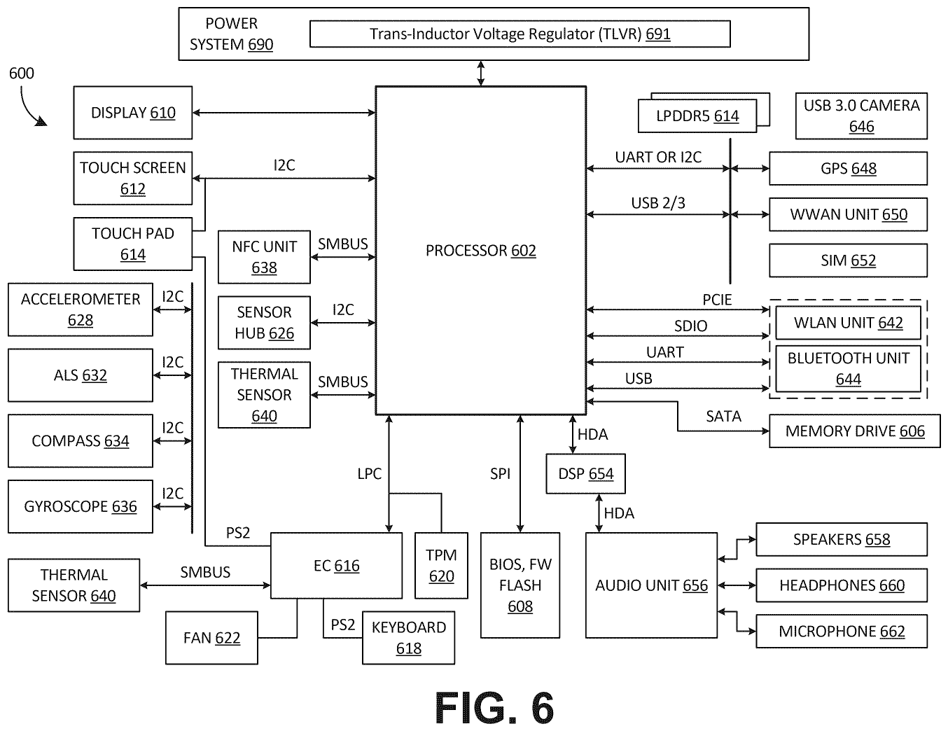

FIG. 6 is a block diagram illustrating an electronic device 600 for utilizing a processor 602, according to aspects of the disclosure. In at least one embodiment, electronic device 600 can be, for example, and without limitation, a notebook, a tower server, a rack server, a blade server, a laptop, a desktop, a tablet, a mobile device, a phone, an embedded computer, or any other suitable electronic device.

In at least one embodiment, one or more of the components of the electronic device 600 can be powered by a power system 690 including a TLVR 691. For example, the power system 690 can be included in a power supply (not illustrated) of the electronic device 600, or at the output from the power supply for the electronic device 600. The power system 690 can be the same as, or similar to the system 402 described above with reference to FIG. 4.

In at least one embodiment, the power system 690 can be representative of distinct power circuitry included in one or more of the components of the electronic device 600. For example, the processor 602 can have power circuitry that includes a TLVR 691 with transformer compensation as described herein (e.g., a power system 690) for powering the processor 602. In another example, the memory drive 606 can have power circuitry that includes a TLVR 691 with transformer compensation as described herein (e.g., a power system 690) for powering the memory drive 606.

In at least one embodiment, electronic device 600 can include, without limitation, processor 602 communicatively coupled to any suitable number or kind of components, peripherals, modules, or devices. In at least one embodiment, processor 602 coupled using a bus or interface, such as an I2C bus, a System Management Bus (SMBus), a Low Pin Count (LPC) bus, a Serial Peripheral Interface (SPI), a High Definition Audio (HDA) bus, a Serial Advance Technology Attachment (SATA) bus, a Universal Serial Bus (USB) (including USB 1.0/1/1, USB 2.0, USB 3.0/3.1 Gen1/3.1 Gen2, and USB4), or a Universal Asynchronous Receiver/Transmitter (UART) bus. In at least one embodiment, FIG. 6 illustrates a system, which includes interconnected hardware devices or “chips,” whereas in other embodiments, FIG. 6 can illustrate an exemplary System on a Chip (SoC). In at least one embodiment, devices illustrated in FIG. 6 can be interconnected with proprietary interconnects, standardized interconnects (e.g., PCIe), or some combination thereof. In at least one embodiment, one or more components of FIG. 6 are interconnected using compute express link (CXL) interconnects.

In at least one embodiment, FIG. 6 can include a display 610, a touch screen 612, a touch pad 614, a Near Field Communications (NFC) unit 638, a sensor hub 626, a thermal sensor 640, an Express Chipset (EC), such as EC 616, a Trusted Platform Module (TPM), such as TPM 620, BIOS/firmware (FW)/flash memory, such as BIOS, FW Flash 608, a DSP 654, a memory drive 606 such as a Solid State Disk (SSD) or a Hard Disk Drive (HDD), a wireless local area network unit (WLAN), such as WLAN unit 642, a Bluetooth unit 644, a Wireless Wide Area Network unit (WWAN), such as WWAN unit 650, a Global Positioning System (GPS) 648, a camera (USB 3.0 camera) 646, such as a USB 3.0 camera, and/or a Low Power Double Data Rate (LPDDR) memory unit, such as LPDDR5 604 implemented in, for example, LPDDR5 standard. These components can each be implemented in any suitable manner.

In at least one embodiment, other components can be communicatively coupled to processor 602 through the components discussed above. In at least one embodiment, an accelerometer 628, Ambient Light Sensor (ALS), such as ALS 632, compass 634, and a gyroscope 636 can be communicatively coupled to sensor hub 626. In at least one embodiment, thermal sensor 640, a fan 622, a keyboard 618, and a touch pad 614 can be communicatively coupled to EC 616. In at least one embodiment, speakers 658, headphones 660, and microphone 662 can be communicatively coupled to an audio unit 656 which can, in turn, be communicatively coupled to DSP 654. In at least one embodiment, audio unit 656 can include, for example, and without limitation, an audio coder/decoder (codec) and a class-D amplifier. In at least one embodiment, a subscriber identification module (SIM) card, such as SIM 652 can be communicatively coupled to WWAN unit 650. In at least one embodiment, components such as WLAN unit 642 and Bluetooth unit 644, as well as WWAN unit 650 can be implemented in a Next Generation Form Factor (NGFF).

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and corresponding set can be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., can be either A or B or C, or any nonempty subset of a set of A and B and C. For instance, in an illustrative example of a set having three members, conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In some embodiments, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In some embodiments, code is stored on a computer-readable storage medium, for example, in form of a computer program comprising a plurality of instructions executable by one or more processors. In some embodiments, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In some embodiments, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in some embodiments, comprises multiple non-transitory computer-readable storage media and one or more of individual non-transitory storage media of multiple non-transitory computer-readable storage media lacks all of the code while multiple non-transitory computer-readable storage media collectively store all of the code. In some embodiments, executable instructions are executed such that different instructions are executed by different processors—for example, a non-transitory computer-readable storage medium stores instructions, and a main central processing unit (CPU) executes some of the instructions while a graphics processing unit (GPU) executes other instructions. In some embodiments, different components of a computer system have separate processors, and different processors execute different subsets of instructions.

Accordingly, in some embodiments, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples or exemplary language (e.g., “such as”) provided herein is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, can be used. It should be understood that these terms cannot be intended as synonyms for each other. Rather, in particular examples, “connected” or “coupled” can be used to indicate that two or more elements are in direct or indirect physical or electrical contact with each other. “Coupled” can also mean that two or more elements are not in direct contact with each other but yet still co-operate or interact with each other.

Unless specifically stated otherwise, it can be appreciated that throughout specification terms such as “processing,” “computing,” “calculating,” “determining,” or like, refer to action and/or processes of a computer or computing system or similar electronic computing device, that manipulates and/or transform data represented as physical, such as electronic, quantities within computing system's registers and/or memories into other data similarly represented as physical quantities within computing system's memories, registers or other such information storage, transmission or display devices.

In a similar manner, the term “processor” can refer to any device or portion of a device that processes electronic data from registers and/or memory and transform that electronic data into other electronic data that can be stored in registers and/or memory. As non-limiting examples, a “processor” can be a CPU or a GPU. A “computing platform” can comprise one or more processors. As used herein, “software” processes can include, for example, software and/or hardware entities that perform work over time, such as tasks, threads, and intelligent agents. Also, each process can refer to multiple processes for carrying out instructions in sequence or in parallel, continuously, or intermittently. The terms “system” and “method” are used herein interchangeably insofar as a system can embody one or more methods, and methods can be considered a system.

In the present document, references can be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References can also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or an interprocess communication mechanism.

Although the discussion above sets forth example implementations of described techniques, other architectures can be used to implement described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A voltage regulator comprising:
a first transformer comprising a first primary winding and a first secondary winding, the first primary winding coupled to a first phase branch to produce a first waveform, wherein the first secondary winding is serially coupled to a compensation branch;
a second transformer comprising a second primary winding and a second secondary winding, the second primary winding coupled to a second phase branch to produce a second waveform, wherein the second secondary winding are serially coupled to the first secondary winding; and
an output node coupled to the first phase branch and the second phase branch to provide an output waveform comprising the first waveform and the second waveform, the output waveform having a transient response based on a first harmonic factor of the first phase branch and a second harmonic factor of the second phase branch.

2. The voltage regulator of claim 1, wherein the first harmonic factor of the first phase branch is selected to optimize the transient response of the output waveform.

3. The voltage regulator of claim 1, wherein the first harmonic factor of the first phase branch is based on a transformer harmonic factor of the first transformer.

4. The voltage regulator of claim 3, wherein the transformer harmonic factor of the first transformer is selected to optimize the transient response of the output waveform.

5. The voltage regulator of claim 1, wherein the first harmonic factor is based on at least an induction value of the first secondary winding of the first transformer.

6. The voltage regulator of claim 5, wherein the first secondary winding has a variable inductance that corresponds to a threshold current, wherein a first current that does not satisfy the threshold current corresponds to a first inductance, and wherein a second current that satisfies the threshold current corresponds to a second inductance.

7. The voltage regulator of claim 6, wherein the first current is smaller than the second current, and wherein the first inductance is larger than the second inductance.

8. The voltage regulator of claim 1, wherein the first harmonic factor is based on at least one or more electrical components electrically coupled in series between the first secondary winding of the first transformer and the second secondary winding of the second transformer.

9. The voltage regulator of claim 8, wherein the one or more electrical components comprise a variable inductor, wherein the variable inductor corresponds to a threshold current, wherein a first current that does not satisfy the threshold current corresponds to a first inductance, and wherein a second current that satisfies the threshold current corresponds to a second inductance.

10. The voltage regulator of claim 1, wherein the compensation branch is electromagnetically coupled to the first phase branch and the second phase branch, and wherein one or more characteristics of a first waveform generated by the first phase branch and a second waveform generated by the second phase branch are based in part on a current that is electromagnetically induced onto the compensation branch by the first phase branch and the second phase branch.

11. A system comprising:
a memory device;
one or more processing devices coupled to the memory device; and
a power supply electrically coupled to the one or more processing devices, the power supply including a voltage regulator comprising:
a first transformer comprising a first primary winding and a first secondary winding, the first primary winding coupled to a first phase branch to produce a first waveform, wherein the first secondary winding is serially coupled to a compensation branch;
a second transformer comprising a second primary winding and a second secondary winding, the second primary winding coupled to a second phase branch to produce a second waveform, wherein the second secondary winding is serially coupled to the first secondary winding; and
an output node coupled to the first phase branch and the second phase branch to provide an output waveform comprising the first waveform and the second waveform, the output waveform having a transient response based on a first harmonic factor of the first phase branch and a second harmonic factor of the second phase branch.

12. The system of claim 11, wherein the power supply is electrically coupled to the memory device.

13. The system of claim 11, wherein the first harmonic factor of the first phase branch of the voltage regulator is selected to optimize the transient response of the output waveform.

14. The system of claim 11, wherein the first harmonic factor of the first phase branch of the voltage regulator is based on a transformer harmonic factor of the first transformer.

15. The system of claim 14, wherein the transformer harmonic factor of the first transformer of the voltage regulator is selected to optimize the transient response of the output waveform from the voltage regulator.

16. The system of claim 11, wherein the first harmonic factor is based on an induction value of at least one of the first secondary winding of the first transformer, or one or more electrical components electrically coupled in series between the first secondary winding of the first transformer and the second secondary winding of the second transformer.

17. The system of claim 16, wherein the inductance value corresponds to a threshold current, wherein a first current that does not satisfy the threshold current corresponds to a first inductance, and wherein a second current that satisfies the threshold current corresponds to a second inductance.

18. The system of claim 11, wherein the system comprises one or more of:
a control system for an autonomous or semi-autonomous machine;
a perception system for an autonomous or semi-autonomous machine;
a system for performing simulation operations;
a system for performing deep learning operations;
a system for generating synthetic data;
a system for generating multi-dimensional assets using a collaborative content platform;
a system implemented using an edge device;
a system implemented using a robot;
a system incorporating one or more virtual machines (VMs);
a system implemented at least partially in a datacenter; or
a system implemented at least partially using cloud computing resources.

19. A voltage regulator comprising:
a plurality of transformers comprising a plurality of primary windings and plurality of secondary windings, wherein the plurality of primary windings are respectively coupled to a plurality of phase branches to produce a plurality of waveforms, and wherein the plurality of secondary windings are electrically coupled in series to a compensation branch; and
an output node coupled to the plurality of phase branches to provide an output waveform comprising the plurality of waveforms, the output waveform having a transient response based on a plurality of harmonic factors corresponding to respective phase branches of the plurality of phase branches.

20. The voltage regulator of claim 19, wherein the compensation branch is electromagnetically coupled to the plurality of phase branches, and wherein one or more characteristics of a plurality of waveforms generated by the plurality of phase branches are based in part on a current that is electromagnetically induced onto the compensation branch by the plurality of phase branches.
